(19) United States
(12) Patent Application Publication
(10) Pub. No.: US 2026/0065438 A1
(43) Pub. Date: Mar. 5, 2026

(54) ELECTRONIC APPARATUS OUTPUTTING IMAGE BY CORRECTING THE SAME AND CONTROL METHOD THEREOF

(71) Applicant: Samsung Electronics Co., Ltd., Suwon-si (KR)

(72) Inventors: Junghyun PARK, Suwon-si (KR); Hyunhee PARK, Suwon-si (KR); Sejun SONG, Suwon-si (KR); Hyungju CHUN, Suwon-si (KR); Jaehyoung PARK, Suwon-si (KR)

(21) Appl. No.: 19/244,588

(22) Filed: Jun. 20, 2025

Related U.S. Application Data
(63) Continuation of application No. PCT/KR2025/006662, filed on May 16, 2025.

(30) Foreign Application Priority Data
Sep. 4, 2024 (KR) 10-2024-0119906
Nov. 22, 2024 (KR) 10-2024-0168430

(51) Int. Cl. G06T 5/70; G06T 5/60

(52) U.S. Cl. CPC G06T 5/70; G06T 5/60; G06T 2207/20084; G06T 2207/20221

(57) ABSTRACT

An electronic apparatus is provided. The electronic apparatus includes a memory, including one or more storage media, storing instructions, a camera, and at least one processor including processing circuitry communicatively coupled to the memory and the camera, and the instructions, when executed by the at least one processor individually or collectively, cause the electronic apparatus to, based on an event for capturing being identified, obtain a plurality of raw images having different exposure values through the camera, obtain an output image by using the plurality of raw images, obtain weight information for each region included in the output image associated with a synthesis degree of each of the plurality of raw images used in obtaining the output image, obtain semantic segmentation information corresponding to the output image, obtain noise information based on the semantic segmentation information and the weight information, and obtain a corrected output image based on the output image and the noise information.

### CROSS-REFERENCE TO RELATED APPLICATION(S)

This application is a continuation application, claiming priority under 35 U.S.C. § 365(c), of an International application No. PCT/KR2025/006662, filed on May 16, 2025, which is based on and claims the benefit of a Korean patent application number 10-2024-0119906, filed on Sep. 4, 2024, in the Korean Intellectual Property Office, and of a Korean patent application number 10-2024-0168430, filed on Nov. 22, 2024, in the Korean Intellectual Property Office, the disclosure of each of which is incorporated by reference herein in its entirety.

### TECHNICAL FIELD

The disclosure relates to an electronic apparatus outputting an image by correcting the same and a control method thereof.

### BACKGROUND ART

There are various methods of adding a noise to an image, and the methods may be mainly used in the areas of image processing and computer vision.

Dithering involves adding a noise to an image, and the process may be used to minimize an image of low bit depth in digital image processing or to minimize color banding, flatness or other visual artifacts in a display, by adding a small amount of noises or a pattern to an image.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide an electronic apparatus outputting an image by correcting the same and a control method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes memory, including one or more storage media, storing instructions, a camera, and at least one processor including processing circuitry communicatively coupled to the memory and the camera, wherein the instructions, when executed by the at least one processor individually or collectively, cause the electronic apparatus to, based on an event for capturing being identified, obtain a plurality of raw images having different exposure values through the camera, obtain an output image by using the plurality of raw images, obtain weight information for each region included in the output image associated with a synthesis degree of each of the plurality of raw images used in obtaining the output image, obtain semantic segmentation information corresponding to the output image, obtain noise information based on the semantic segmentation information and the weight information, and obtain a corrected output image based on the output image and the noise information.

In accordance with another aspect of the disclosure, a method of controlling an electronic apparatus is provided. The method includes based on an event for capturing being identified, obtaining a plurality of raw images having different exposure values through a camera, obtaining an output image by using the plurality of raw images, obtaining weight information for each region included in the output image associated with a synthesis degree of each of the plurality of raw images used in obtaining the output image, obtaining semantic segmentation information corresponding to the output image, obtaining noise information based on the semantic segmentation information and the weight information, and obtaining a corrected output image based on the output image and the noise information.

In accordance with another aspect of the disclosure, one or more non-transitory computer-readable storage media storing one or more computer programs including computer-executable instructions that, when executed by one or more processors individually or collectively, cause an electronic apparatus to perform operations are provided. The operations include based on an event for capturing being identified, obtaining a plurality of raw images having different exposure values through a camera, obtaining an output image by using the plurality of raw images, obtaining weight information for each region included in the output image associated with a synthesis degree of each of the plurality of raw images used in obtaining the output image, obtaining semantic segmentation information corresponding to the output image, obtaining noise information based on the semantic segmentation information and the weight information, and obtaining a corrected output image based on the output image and the noise information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with accompanying drawings, in which:

FIG. 1 illustrates an image processing method of an electronic apparatus according to an embodiment of the disclosure;

FIGS. 2A, 2B, 2C, and 2D illustrate an image processing method of an electronic apparatus according to various embodiments of the disclosure;

FIG. 3 illustrates a block diagram of an electronic apparatus according to an embodiment of the disclosure;

FIG. 4 is a flowchart illustrating an operation of an electronic apparatus according to an embodiment of the disclosure;

FIGS. 5A and 5B illustrate a method of obtaining weight information according to various embodiments of the disclosure;

FIG. 6 illustrates a method of obtaining semantic segmentation information according to an embodiment of the disclosure;

FIG. 7 illustrates a method of obtaining noise information according to an embodiment of the disclosure;

FIG. 8 illustrates an image-processed output image according to an embodiment of the disclosure;

FIGS. 9A and 9B illustrates a method of obtaining noise information based on weight information according to various embodiments of the disclosure;

FIGS. 10A and 10B illustrates a method of obtaining noise information based on semantic segmentation information according to various embodiments of the disclosure;

FIGS. 11A and 11B illustrates a method of obtaining noise information based on semantic segmentation information according to various embodiments of the disclosure;

FIG. 12 illustrates a method of correcting an output image according to an embodiment of the disclosure; and

FIG. 13 is a block diagram of an electronic apparatus in a network environment according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

In the disclosure, the expression “have”, “may have”, “include”, “may include” or the like, indicates the existence of a corresponding feature (e.g., a numerical value, a function, an operation or an element, such as a part), and does not exclude the existence of an additional feature.

The expression at least one from A or/and B is to be understood as indicating any one of “A”or “B”or “A and B”.

The expression “1st”, “2nd”, “first”, “second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), it is to be understood that one element may be connected to another element directly, or through yet another element (e.g., a third element).

In the disclosure, singular forms include plural forms as well, unless explicitly indicated otherwise. In the disclosure, the term “include” or “composed of” and the like means the presence of stated features, integers, steps, operations, elements, components or combinations thereof but do not imply the exclusion of the presence or addition of one or more other features, integers, steps, operations, elements, components or combinations thereof.

In the embodiments of the disclosure, the term “module” or “unit” may perform at least one function or operation, and be implemented by hardware or software or by a combination of hardware and software. Additionally, a plurality of “modules” or a plurality of “units” may be integrated into at least one module and be implemented by at least one processor except for a “module” or a “unit” that needs to be implemented by specific hardware.

In the disclosure, the term “user” may refer to a person who uses an electronic apparatus or an apparatus (e.g., an AI electronic apparatus) which uses an electronic apparatus.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Various elements and regions in the drawings are schematically illustrated. Accordingly, the technical spirit of the disclosure is not limited by relative sizes or distances illustrated in the accompanying drawings.

Hereinafter, embodiments of the disclosure are described in greater detail with reference to the accompanying drawings.

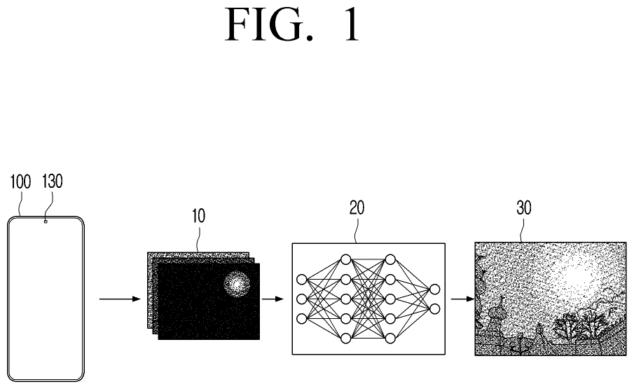

FIGS. 1 2A,2B, 2C, and 2D illustrate an image processing method of an electronic apparatus according to various embodiments of the disclosure.

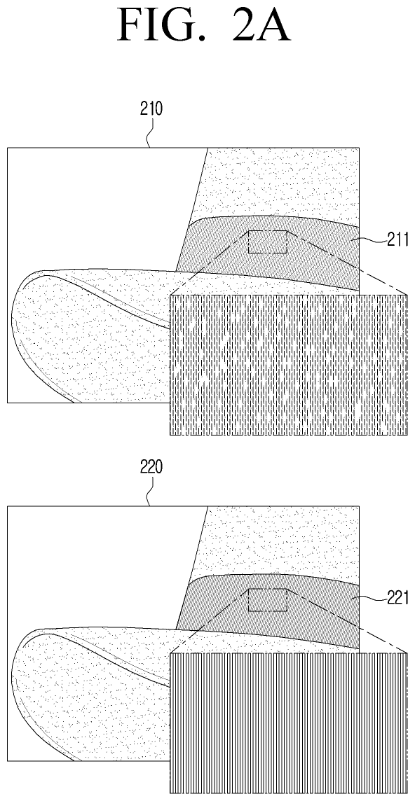

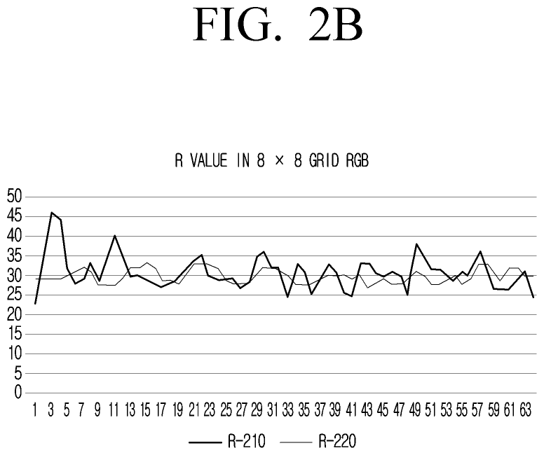

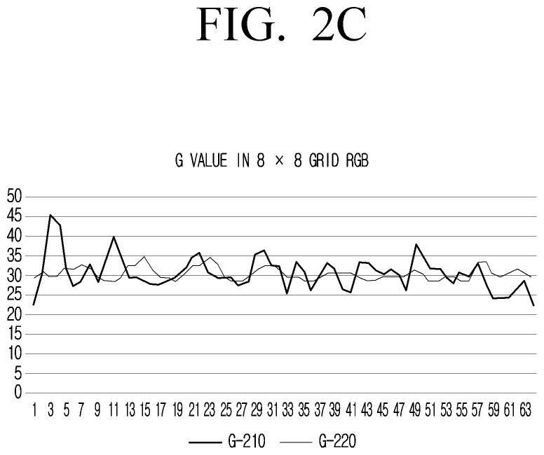

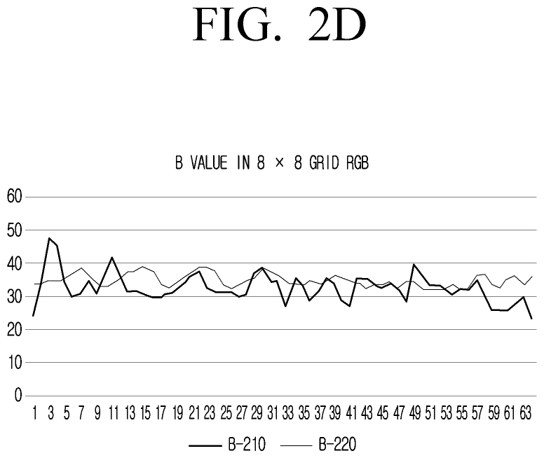

Referring to FIGS. 1, 2A, 2B, 2C, and 2D, according to one embodiment of the disclosure, the electronic apparatus 100 may obtain raw data by performing capturing through a camera 130 based on an event for capturing.

The raw data may be an image file in which original data captured by a camera sensor are stored in a non-processed state. For example, the raw data may include a pure image-sensor output data to which an image processing procedure is not applied.

In one example, the raw data may include a plurality of raw images 10, as illustrated in FIG. 1. The plurality of raw images (or raw frames) may also be referred to as a multi-image raw file (a multi-frame raw (MFR) file).

The plurality of raw images may be images that are generated based on multiple capturing. For example, the camera 130 may capture several images continuously at very short time intervals, and the images may all be stored in the form of raw data. At a time of capturing, each image may have a subtle difference. For example, each image may have a different exposure value.

According to one embodiment of the disclosure, the electronic apparatus 100 may synthesize and image-process the plurality of raw images 10 by using an AI model 20 (or a neural network model). For example, the electronic apparatus 100 may obtain an output image 30 in which the plurality of raw images are synthesized by inputting the plurality of raw images to the AI model 20.

According to one embodiment of the disclosure, the AI model 20 may be implemented as an image-to-image AI model that outputs an image-processed image, in the case where an image is input. The image-to-image AI model may be a deep learning model that performs a task of generating an output image through image processing in the case where at least one image is input. For example, the image-to-image AI model may be implemented as an AI model using a deep learning algorithm, such as a generative adversarial network (GAN), a variational autoencoder (VAE), or a diffusion model. Image processing may be digital image processing including at least one of image enhancement, image restoration, image transformation, image analysis, image understanding, image compression, image decoding or scaling.

Ordinarily, due to the phenomenon of regression to the mean, a phenomenon where an image looks blurry may occur in an output image 30 output from the image-to-image AI model. Since an image is seen clearly to the user's eye in the case of a big change in a pixel value, in the case where there is a phenomenon in which a pixel value returns to an average pixel value, the image may relatively look blurry due to a decrease in the change.

In one example, the drawing in the upper direction of FIG. 2A shows one example of a first image 210 before an input to the AI model 20, and the drawing in the lower direction of FIG. 2A shows one example of a second image 220 that is output from the AI model 20. In one example, as a result of comparison between a strap area 211 of a hat portion in the first image 210 and a strap area 221 of an identical hat portion in the second image 220, a phenomenon in which the image looks blurry in the strap area 221 of the hat portion in the second image 220 occurs due to the phenomenon of regression to the mean.

For example, FIGS. 2B, 2C, and 2D are charts showing red (R) pixel values, green (G) pixel values, and blue (B) pixel values of 8×8 grid areas in the strap areas 211, 221 of the hat portions in the first image 210 and the second image 220.

Referring to FIG. 2B, a line of R-210 indicates an R pixel value of the first image 210, and a line of R-220 indicates an R pixel value of the second image 220.

Referring to FIG. 2C, a line of G-210 indicates a G pixel value of the first image 210, and a line of G-220 indicates a G pixel value of the second image 220.

Referring to FIG. 2D, a line of B-210 indicates a B pixel value of the first image 210, and a line of B-220 indicates a B pixel value of the second image 220.

Referring to FIGS. 2B, 2C, and 2D, it turns out that a range of changes in the pixel values of the second image 220 that is output from the AI model 20 is less than a range of changes in the pixel values of the first image 210 that is yet to be input to the AI model 20.

In this case, an addition of a proper noise to the second image 220 may result in an improved texture and a more natural-looking image, alleviating the phenomenon of regression to the mean.

Hereinafter, described are various embodiments of enhancing quality of the second image 220 by generating an effective noise with weight information of the AI model 20 rather than merely generating a uniform noise.

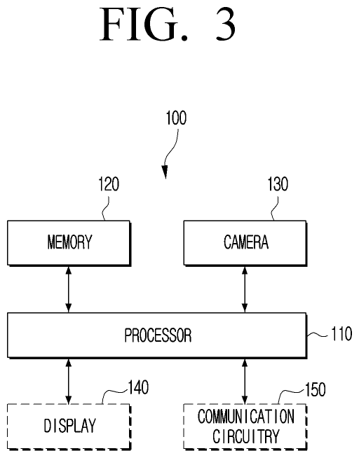

FIG. 3 is a view illustrating a block diagram of an electronic apparatus according to an embodiment of the disclosure.

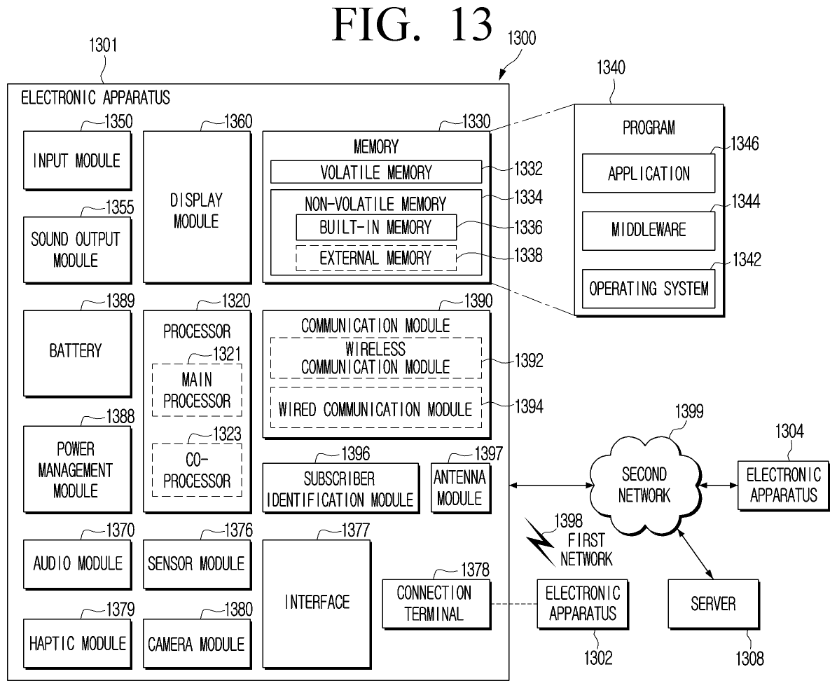

Referring to FIG. 3, an electronic apparatus 100 according to various embodiments may be at least partially similar to an electronic apparatus 1301 of FIG. 13, or include other embodiments of the electronic apparatus.

According to one embodiment of the disclosure, in the case of an electronic apparatus possessed by the user, the electronic apparatus 100 may be referred to as a terminal (or a user terminal). The terminal, for example, may include a personal computer (PC), such as a laptop and a desktop. The terminal, for example, may include a smartphone, a smart pad and/or a tablet PC. The terminal may include smart accessories, such as a smartwatch and/or a head-mounted device (head-mounted device). The electronic apparatus 100 according to one embodiment may include a deformable housing. Based on deformability, the housing of the electronic apparatus 100 may be divided into a plurality of portions.

The electronic apparatus 100 according to one embodiment may include at least one of a processor 110, memory 120, a camera 130, a display 140 or communication circuitry 150. The processor 110, the memory 120, the camera 130, the display 140 and the communication circuitry 150 may be electronically and/or operably connected (coupled) with each other by an electronical component, such as a communication bus.

In one embodiment of the disclosure, the operable coupling of the hardwares of the electronic apparatus 100 may denote establishing a direct connection, or an indirect connection between hardwares in a wired manner, or a wireless manner, such that a second hardware may be controlled by a first hardware among the hardwares. The embodiment is illustrated based on different blocks, but not limited thereto, and part (e.g., at least part of a processor 110, memory 120 and communication circuitry 150) of the hardwares of FIG. 3 may be included in a single integrated circuit, such as a system on a chip (SoC). The type and/or number of hardwares included in the electronic apparatus 100 are not limited to the hardwares illustrated in FIG. 3. For example, the electronic apparatus 100 may include some of the hardware components illustrated in FIG. 3

The processor 110 of the electronic apparatus 100, according to one embodiment of the disclosure, may include a hardware for processing data based on one or more instructions. The hardware for processing data, for example, may include an arithmetic and logic unit (ALU), a floating point unit (FPU), a field programmable gate array (FPGA), a central processing unit (CPU), a graphics processing unit (GPU), a neural processing unit (NPU) and/or an application processor (AP). The number of the processors 110 may be one or more. For example, the processor 110 may have a structure the same as the structure of a multi-core processor, such as a dual-core processor, a quad-core processor, or a hex-core processor.

The CPU, as a general purpose processor capable of performing an AI computation as well as a normal computation, may efficiently execute a complex program through a multi-level cache structure. The CPU is advantageous in a series processing method enabling an organic connection between previous calculation results and following calculation results through a consecutive calculation. The general purpose processor is not limited to the above-described examples, unless explicitly indicated as the above-described CPU.

The GPU, as a processor for a massive computation, such as a floating-point computation and the like used to process graphics, may perform a massive computation in parallel by integrating cores in massive amounts. More particularly, the GPU may be more advantageous in a parallel processing method, such as a convolution computation and the like than the CPU. Additionally, the GPU may be used as a co-processor for complementing a function of the CPU. A processor for a massive computation is not limited to the above-described examples, unless explicitly indicated as the above-described GPU.

The NPU, as a processor specializing in an AI computation using an artificial neural network, may be implemented in the way that each layer constituting an artificial neural network is implemented as hardware (e.g., silicon). At this time, since the NPU is designed specially according to specifications required by a business, a freedom degree of the NPU is less than that of the CPU or the GPU, but may process an AI computation required by a business efficiently. Meanwhile, as a processor specializing in an AI computation, the NPU may be implemented in various forms, such as a tensor processing unit (TPU), an intelligence processing unit (IPU), a vision processing unit (VPU) and the like. An artificial intelligence processor is not limited to the above examples, unless explicitly indicated as the above-described NPU.

The memory 120 of the electronic apparatus 100 according to one embodiment may include a hardware component for storing data and/or instructions input to and/or output from the processor 110. The memory 120, for example, may include volatile memory, such as random-access memory (RAM) and/or non-volatile memory, such as read-only memory (ROM). The volatile memory, for example, may include at least one of dynamic RAM (DRAM), static RAM (SRAM), cache RAM, and pseudo SRAM (PSRAM). The non-volatile memory, for example, may include at least one of programmable ROM (PROM), erasable PROM (EPROM), electrically erasable PROM (EEPROM), flash memory, hard disk, compact disk, solid state drive (SSD), and an embedded multimedia card (eMMC).

According to one embodiment of the disclosure, a computation to be performed by the processor 110 on data, and/or one or more instructions (or commands) indicating operations may be stored in the memory 120 of the electronic apparatus 100. A set of one or more instructions may be referred to as firmware, an operating system, a process, a routine, a sub-routine and/or an application. For example, the electronic apparatus 100, and/or the processor 110 may perform various functions when a set of a plurality of instructions distributed in the form of an operating system, firmware, a driver, and/or an application is executed. Hereinafter, installing an application in the electronic apparatus 100 may denote storing one or more instructions provided in the form of an application in the memory 120 of the electronic apparatus 100, and storing the one or more instructions in a format (e.g., a file having an extension designated by the operating system of the electronic apparatus 100) that is executable by the processor 110 of the electronic apparatus 100.

One or more processors 110 may control to process input data, according to a predefined operation rule or an artificial intelligence model that is stored in the memory 120. The predefined operation rule or the AI model is characterized in that the predefined operation rule or the AI model is made through learning. Making the predefined operation rule or the AI model through learning denotes making a predefined operation rule or an AI model of desired characteristics, by applying a learning algorithm to a large number of learning data. Such learning may be performed in an apparatus itself in which artificial intelligence according to the disclosure is performed, or performed through a separate server/system.

The AI model may be comprised of a plurality of neural network layers. At least one layer has at least one weight value, and a computation of layers is performed through results of a computation of a previous layer and at least one defined computation. Examples of the neural network may include a convolutional neural network (CNN), a recurrent neural network (RNN), a deep neural network (DNN), a restricted boltzmann machine (RBM), a deep belief network (DBN), a bidirectional recurrent deep neural network (BRDNN), and a deep Q-network, and a transformer, but the neural network in the disclosure is not limited to the above examples, unless explicitly stated otherwise.

The learning algorithm is a method that trains a predetermined object device (e.g., a robot) by using a large number of learning data, enabling the predetermined object device to make its own decision or prediction. Examples of the learning algorithm may include supervised learning, unsupervised learning, semi-supervised learning or reinforcement learning, but the learning algorithm in the disclosure is not limited to the above examples, unless explicitly stated otherwise.

According to one embodiment of the disclosure, the camera 130 of the electronic apparatus 100 may be turned on according to a preset event to perform capturing. The camera 130 may convert a captured (or imagined) image into an electrical signal, and based on the converted signal, generate image data. For example, a subject may be converted into an electrical image signal through a semiconductor optical device (a charge coupled device (CCD)), and the converted image signal may be amplified and converted into a digital signal and then signal-processed. For example, the camera 130 may include at least one of a normal (or basic) camera, an ultra-wide-angle camera and a depth camera.

According to one embodiment of the disclosure, the display 140 of the electronic apparatus 100 may output visualized information to the user. For example, the display 140 may be controlled by a controller, such as a graphics processing unit and output visualized information to the user. The display 140 may include an organic light emitting diode (OLED) display, a light emitting diode (LED), a micro LED, a Mini LED, a plasma display panel (PDP), a quantum dot (QD) display, a quantum dot light-emitting diode (QLED) and/or an e-ink display or/and an e-paper display. In one example, the display 140 may be implemented as a flat display, a curved display, a foldable or/and rollable flexible display and the like.

According to one embodiment of the disclosure, the communication circuitry 150 of the electronic apparatus 100 may include hardware for assisting with transmission and/or receipt of an electrical signal between the electronic apparatus 100 and an external apparatus (e.g., a server). The communication circuitry 150, for example, may include at least one of a modem, an antenna, and an optic/electronic (O/E) converter. The communication circuitry 150 may assist with transmission and/or receipt of an electrical signal based on various types of protocols, such as an Ethernet, a local area network (LAN), a wide area network (WAN), wireless fidelity (Wi-Fi), near field communication (NFC), Bluetooth™, Bluetooth low energy, (BLE), ZigBee, long term evolution (LTE), fifth generation (5G) new radio (NR) and/or sixth generation (6G).

In one example, the electronic apparatus 100 and a server may be connected with each other based on a wired network and/or a wireless network. The wired network may include networks, such as the Internet, a local area network (LAN), a wide area network (WAN), an Ethernet or a combination thereof. The wireless network may include networks, such as long term evolution (LTE), 5G new radio (NR), wireless fidelity (Wi-Fi), Zigbee, near field communication (NFC), Bluetooth, Bluetooth low-energy (BLE) or a combination thereof. In one example, the electronic apparatus 100 and the server may be connected indirectly through an intermediate node in a network.

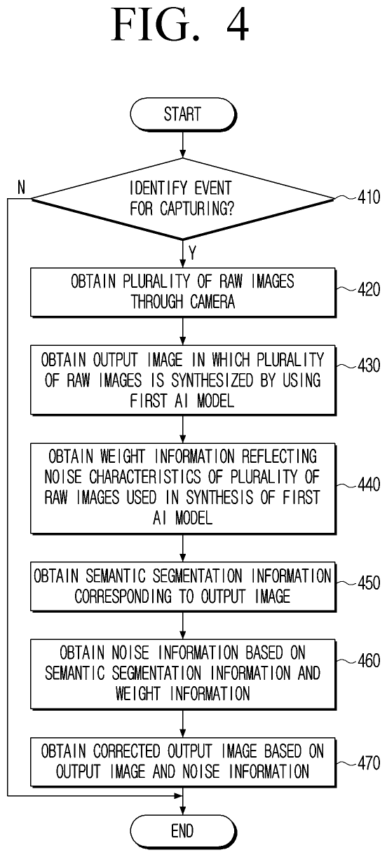

FIG. 4 is a flowchart illustrating an operation of an electronic apparatus according to an embodiment of the disclosure.

Each step in the embodiments described hereinafter may be performed consecutively, but not necessarily performed consecutively. For example, the order of each step may be changed, and at least two steps may be performed in parallel.

Referring to FIG. 4, according to one embodiment of the disclosure, operations 410 through 470 may be understood as being performed in the processor 110 of the electronic apparatus 100.

In operation 410, the electronic apparatus 100 may identify an event for capturing. The event for capturing may be an event in which capturing is started through the camera 130. In an example, the electronic apparatus 100 may identify that the event for capturing has occurred based on at least one of receipt of an instruction for capturing, (e.g., a button input, voice receipt, a gesture recognition and the like), a passage of preset time and a satisfaction of preset conditions.

When identifying the event for capturing (operation 410:Y), the electronic apparatus 100 may obtain a plurality of raw images through the camera 130 in operation 420. In one example, the camera 130 may generate the plurality of raw images (or a multi-image raw file) through multiple exposure capturing. The multi exposure capturing may denote a method in which an identical scene is captured several times in various exposure settings. For example, a low-exposure image for details of a dark portion, a high-exposure image for details of a bright portion, and a medium-brightness image may be captured. Accordingly, the plurality of raw images may have different exposure values.

In one example, in the case where the event for capturing is identified, the camera 130 may set an automatic focal point AF and an automatic exposure AE, before a shutter opens. In this process, the camera 130 may measure a distance of a subject, and determine proper exposure settings (e.g., ISO, a shutter speed, and an aperture) appropriate for an environment. Then while the shutter of the camera 130 opens, light comes into an image sensor (e.g., a CMOS or a CCD) such that an image is captured. In this process, the image sensor of the camera 130 may convert the light into an electrical signal.

In one example, the camera 130 may store, in the memory 120, raw data that are obtained by capturing several images continuously at very short time intervals while changing the exposure settings for multi exposure capturing.

In operation 430, the electronic apparatus 100 may obtain an output image by using the plurality of raw images. In one example, the electronic apparatus 100 may obtain an output image in which the plurality of raw images is synthesized by using an image conversion module (or image processing software). In one example, the image conversion module may include a first AI model.

In one example, the first AI model may be implemented as an image-to-image AI model for enhancing image quality. The image-to-image AI model may be a deep learning model that performs a task of generating an output image based on image processing in the case where at least one image is input. For example, the image-to-image AI model may be implemented as an AI model using a deep learning algorithm, such as generative adversarial networks (GANs), variational autoencoders (VAEs), or diffusion models.

In one example, in the case where the plurality of raw images is input, the first AI model may output one output image by synthesizing the plurality of raw images. In one example, the first AI model may generate one output image by de-noising the plurality of raw images. However, the first AI model is not limited thereto, and the first AI model may generate an output image by synthesizing the plurality of raw images based on various types of image processing, such as a multiple exposure synthesis, quality improvement, a color correction, a white balance, an adjustment of a high dynamic range (HDR) and the like on the plurality of raw images.

Hereinafter, description is provided under the assumption that the first AI model generates an output image (or an output image) by multi-exposure synthesizing (by performing multi-exposure fusion) the plurality of raw images for convenience of description. The multi-exposure synthesis may be image processing in which a plurality of raw images captured under different exposure conditions is synthesized to generate an output image.

The exposure may denote a degree to which the image sensor is exposed to light, and determined based on a shutter speed, an aperture value and/or ISO settings. For example, the greater the exposure (over exposure) is, the brighter the image is, and the less the exposure (under exposure) is, the darker the image is.

The synthesis (fusion) may be combining several raw images captured and selecting a portion having optimal exposure only from each of the raw images, to generate one output image. In this process, the first AI model may combine proper portions by analyzing the brightness, contrast and color of each of the raw images. In one example, the first AI model may select a low-exposure image in a bright region, and a high-exposure image in a dark region, to generate an output image. For example, the first AI model may select a bright sky region from a low-exposure image and a dark shadow region from a high-exposure image, and generate an output image. This is because the dark portion may hardly be seen while the bright sky region may not disappear due to over exposure in the low-exposure image, and details of the sky region may disappear since the sky region is excessively bright while the dark portion is seen well in the high-exposure image. In this process, the first AI model may blend a boundary portion such that a seam may not be seen for a natural conversion.

In operation 440, the electronic apparatus 100 may obtain weight information for each region associated with a synthesis degree of the plurality of raw images.

According to one embodiment of the disclosure, the electronic apparatus 100 may obtain weight information from the first AI model. The weight information may include information on a synthesis degree of a plurality of raw images of each region included in the output image. The synthesis degree may be information as to how much a specific region of each of the raw images contributes to a final synthesis image in the case where the first AI model combines the raw images captured under different exposure conditions. For example, the weight information may be determined based on brightness, contrast, a noise level and the like of each raw image. For example, since it is highly likely that a noise is left on the output image in the case where a raw image of a low EV value (e.g., −2 EV) contributes to a synthesis, the weight information may reflect noise characteristics of the plurality of raw images.

In one example, the weight information used at a time of synthesis of an image by the first AI model may be stored in the memory 120. Accordingly, the electronic apparatus 100 may obtain the weight information stored in the memory 120.

In one example, the weight information may be formed into a weight map (hereinafter, a first map) including a weight of each region of an image. For example, the weight map may include a weight corresponding at least one of the plurality of raw images of each region. In the disclosure, the “region” refers to one portion of an image, and denote at least one pixel block or a collection of pixel blocks. Additionally, the “pixel block”denotes a collection of adjacent pixels including at least one pixel.

In operation 450, the electronic apparatus 100 may obtain semantic segmentation information corresponding to an output image.

In one example, the electronic apparatus 100 may obtain semantic segmentation information corresponding to the output image by using a second AI model.

The semantic segmentation information may be information in which each pixel in an image is classified into a specific class (e.g., human, sky, tree, vehicle and the like). In one example, the semantic segmentation information may be formed into a map (hereinafter, a second map) including semantic information of each region of an image. The second map may be formed into a label (e.g., a color, an indicator, a flag, a text and the like) indicating an object or a background to which each pixel of the image belongs. In one example, semantic segmentation may involve segmenting all objects belonging to an identical class in an identical manner rather than segmenting an individual object. For example, in an image where there are humans, all the humans may be classified into an identical class of “human”. In one example, the second map may have the same resolution as that of an input image, and provide a precise classification based on a pixel unit.

In one example, the second AI model may allocate each pixel included in an image to a specific class. For example, in an image showing a road, each pixel may be classified into classes, such as “road”, “vehicle”, “pedestrian, “sky” and the like. For example, in the second map, each pixel may include a predefined class label. The class label may be information indicating which class is matched by a corresponding pixel in an image. For example, in the case where the label is expressed as colors, the road may be expressed as gray, the vehicle may be expressed as red, and the pedestrian may be expressed as green.

In one example, the second AI model may be implemented as a deep learning model using a convolutional neural network (CNN). For example, the second AI model may be implemented as fully convolutional network (FCN), U-Net, SegNet, DeepLab and the like. The second AI model may learn characteristics of an image and predict a class label most appropriate for each pixel.

In operation 460, the electronic apparatus 100 may obtain noise information based on the semantic segmentation information and the weight information. For example, the noise information may be information on a noise to be added to an output image through dithering.

According to one embodiment of the disclosure, the electronic apparatus 100 may obtain the noise information based on the first map including the weight information, the second map including the semantic segmentation information, and the output image.

In one example, the exposure value may be a combination of an aperture (f/value) determining brightness of an image, a shutter speed, and ISO. As the exposure value is high (e.g., EV+1, +2), an image becomes brighter, and as the exposure value is low (e.g., EV−1, −2) an image becomes darker. The noise as an unnecessary noise in an image may be mainly generated in the image sensor of the camera 130. For example, an increase in the ISO may lead to an increase in the noise as well as an increase in sensitivity of the image sensor. Accordingly, a change in the EV value may result in a change in the amount and characteristics of a noise shown in an image.

In one example, in an image of a low EV (e.g., an image captured at an EV darker than a basic EV of 0, more noises are likely to occur in a dark portion. This is because a noise is increased while the image sensor detects light more sensitively when the camera 130 corrects the dark portion. On the other hand, in an image of a high EV (e.g., an image captured at an EV brighter than an existing EV of 0, a noise is less likely to occur.

Thus, the weight information, i.e., the first map, may be characterized by including noise characteristics of the plurality of raw images. Since the first map includes characteristics of a noise for each frame, a noise level of a synthesized result may be predicted, and based on the noise level, the noise level may be adjusted such that an effective noise may be added. Accordingly, a noise appropriate for an output image may be generated in the case where the noise information is generated based on the first map including the weight information.

According to one embodiment of the disclosure, the electronic apparatus 100 may obtain noise information by inputting the first map including the weight information, the second map including the semantic segmentation information, and the output image to the second AI model. In one example, the noise information may include digital grain information. Digital grain may be a pattern, such as a small particle shown in a digital image.

In operation 470, the electronic apparatus 100 may obtain a corrected output image (or a final output image) based on the output image and the noise information. For example, the noise information may be formed into a noise image (or a noise map) including a noise value for each pixel. In one example, the electronic apparatus 100 may obtain the output image through dithering.

In one example, the electronic apparatus 100 may obtain a corrected output image by blending the noise image to the output image. For example, the electronic apparatus 100 may blend a pixel value of the output image and a pixel value included in the noise map through alpha blending. For example, the electronic apparatus 100 may blend the pixel value of the output image and the pixel value included in the noise map based on a formula “Blended image=α×output image+(1−α)×noise image”. Herein, the α value may be a weighted sum ratio of the output image and the noise image. For example, as α becomes closer to 1, the output image may be reflected further, and as α becomes closer to 0, the noise image may be reflected further. The α value may be a preset value, but may be set/changed based on a user input.

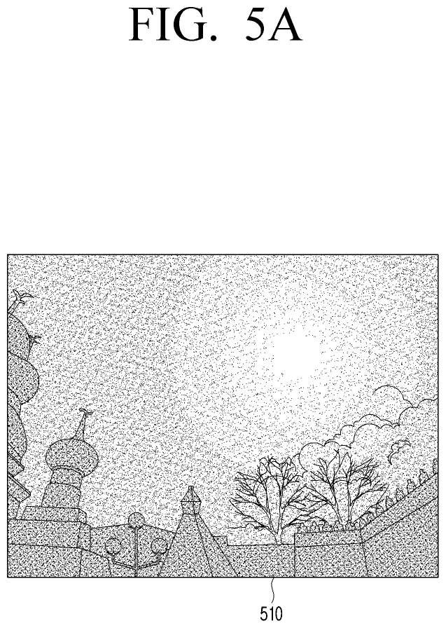

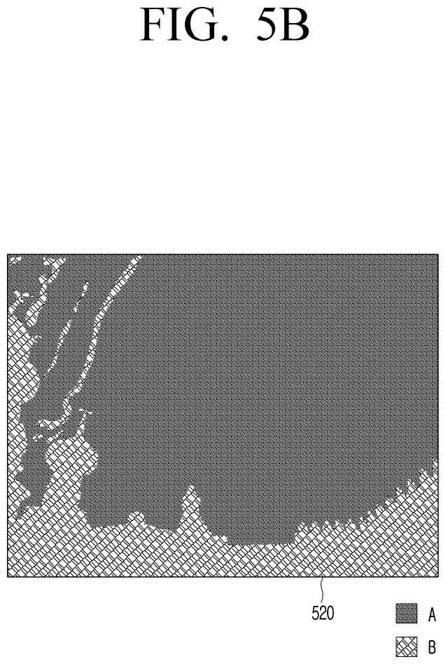

FIGS. 5A and 5B illustrates a method of obtaining weight information according to various embodiments of the disclosure.

According to one embodiment of the disclosure, the electronic apparatus 100 may obtain weight information by using the first AI model 20. For example, the electronic apparatus 100, as illustrated in FIG. 1, may obtain an output image in which a plurality of raw images obtained through capturing is synthesized by inputting the plurality of raw images to the first AI model 20.

Referring to FIG. 5A, it illustrates one example of an output image 510. For example, the output image 510 may be an image that is a bit blurred due to the phenomenon of regression to the mean described with reference to FIG. 1.

Referring to FIG. 5B, it illustrates one example of weight information obtained from the first AI model 20, e.g., a first map 520.

In one example, the first map 520 may include weigh information of synthesis information for each region of raw frames having a different EV. For example, as a weight of color “A” becomes higher in the first map 520, this means that more raw images having a low EV value may be synthesized, and as a weight of color “B” becomes higher, this means that more raw images having a high EV value may be synthesized.

In one example, it is highly likely that more noises occur in a dark portion in the case of an image of a low EV, and it is less likely that a noise occurs in the case of an image of a high EV. Accordingly, the weight information, i.e., the first map may be characterized by including noise characteristics of the plurality of raw images. Since the first map includes noise characteristics of each frame, a noise level of a synthesized result may be predicted, and based on the noise level, the noise level may be adjusted such that an effective noise may be added. Accordingly, a noise appropriate for an output image may be generated in the case where the noise information is generated based on the first map including the weight information.

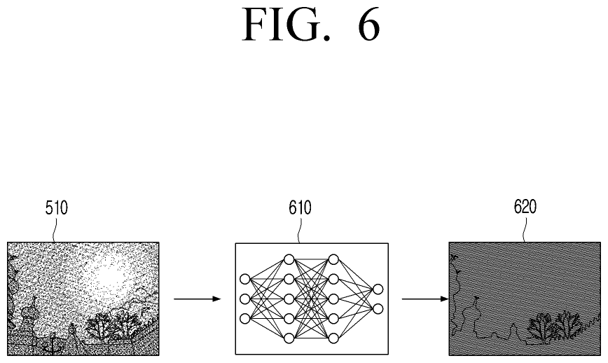

FIG. 6 illustrates a method of obtaining semantic segmentation information according to an embodiment of the disclosure.

Referring to FIG. 6, according to one embodiment of the disclosure, the electronic apparatus 100 may obtain semantic segmentation information 620 by inputting an output image 510 to a second AI model 610 as illustrated in FIG. 6. In one example, the semantic segmentation information may be formed into a map (a second map) including semantic information of each region of an image.

In one example, the second AI model 610 may allocate each pixel included in the output image 510 to a specific class. Accordingly, the semantic segmentation information 620 may include class information corresponding to each pixel. For example, the semantic segmentation information 620 may be implemented as a second map including a class label to which each pixel corresponds. For example, in the case where the class label is expressed as colors, the semantic segmentation information 620 may be implemented as a second map in which each pixel included in the second map includes colors corresponding to classes of sky, cloud, building, tree and the like. In the case where the class label is expressed as colors, the electronic apparatus 100 may previously store the class information corresponding each of the colors. For example, in the case where the class label is expressed as a text, the semantic segmentation information 620 may be implemented as a second map in which each pixel included in the second map includes texts corresponding to classes of sky, cloud, building, tree and the like.

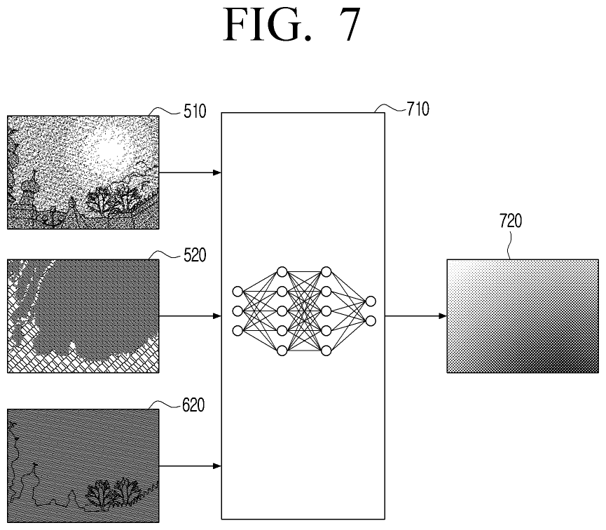

FIG. 7 illustrates a method of obtaining noise information according to an embodiment of the disclosure.

Referring to FIG. 7, according to one embodiment of the disclosure, the electronic apparatus 100, as illustrated in FIG. 7, may obtain noise information 720 by inputting the output image 510, the weight information and the semantic segmentation information (the second map) 620 to a third AI model 710. In one example, the noise information may include digital grain information as illustrated in FIG. 7. Digital grain may be a small-particle pattern shown in a digital image.

According to one embodiment of the disclosure, the electronic apparatus 100 may obtain the noise information by adjusting a weight for each region included in weight information of the output image, based on the semantic segmentation information of each region included in the output image.

In one example, in the case where a first region and a second region included in the output image include a pixel value of a raw image of which an exposure value is relatively low among a plurality of raw images, the electronic apparatus 100 may adjust the noise information based on semantic segmentation information of the first region and the second region. For example, when identifying that a first object included in the first region is an object which requires a detail enhancing processing compared to a second object included in the second region based on the semantic segmentation information of the first region and the second region, the electronic apparatus 100 may obtain the noise information in which a noise of the first region is greater than a noise of the second region.

In one example, the electronic apparatus 100, as illustrated in FIG. 7, may obtain the noise information by inputting weight information and semantic segmentation information together to a trained third AI model 710.

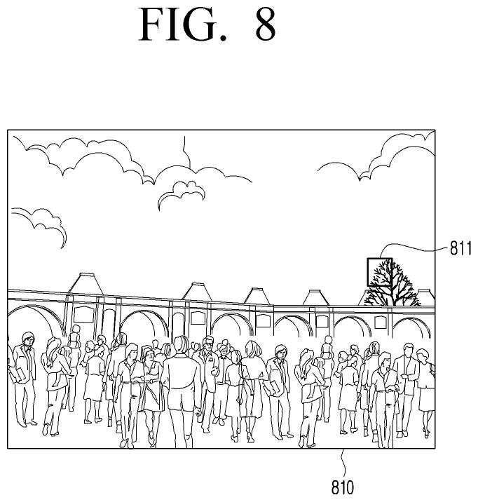

Hereinafter, a method of obtaining noise information according to various embodiments is described with reference to FIGS. 8, 9A, 9B, 10A, 10B, 11A, and 11B.

FIG. 8 illustrates an image-processed output image according to an embodiment of the disclosure.

FIG. 8 illustrates an output image 810 in one example. For example, the output image 810 may be an output image obtained through the first AI model 20. For convenience of description, one region including the sky and a tree in the output image 810 is set to a region of interest 811, and a method of obtaining noise information of the region of interest 811 is described.

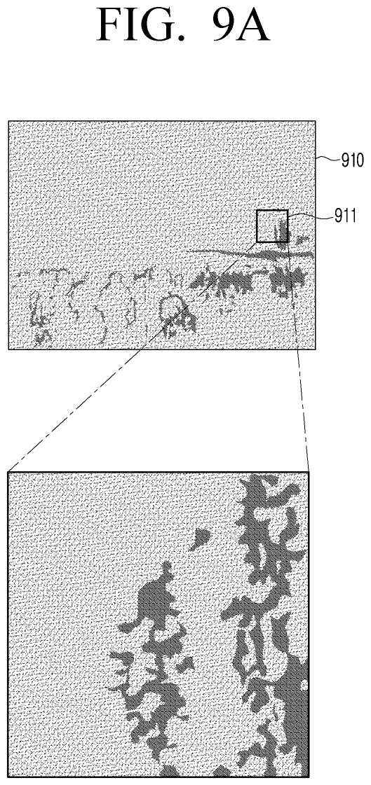

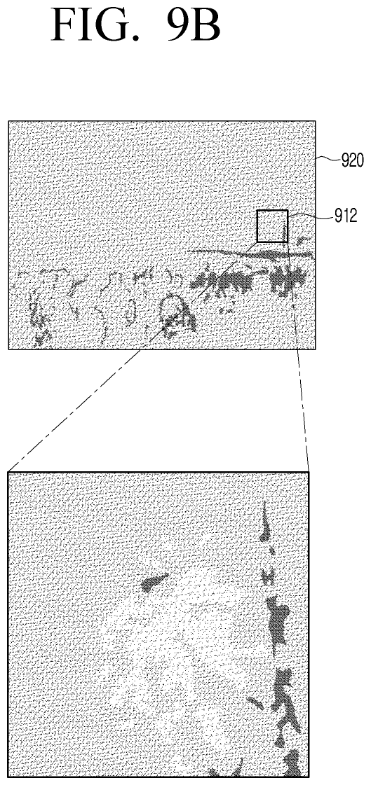

FIGS. 9A and 9B illustrates a method of obtaining noise information based on weight information according to various embodiments of the disclosure.

Referring to FIGS. 9A and 9B, they illustrate a weight map of a different epoch, as one example of the weight information (a first map) corresponding to the output image 810 illustrated in FIG. 8. The epoch may be the number of training cycles in which learning of all training data is completed when a neural network is trained. For example, epoch=10 may mean that all data is used 10 times to perform training.

In one example, a weight map 910 illustrated in FIG. 9A may be a map corresponding to epoch=4980, and a weight map 920 illustrated in FIG. 9B may be a map corresponding to epoch=12020.

In the weight maps 910, 920 illustrated in FIGS. 9A and 9B, weight information 911, 912 corresponding to the region of interest 811 is compared.

For example, as for a branch region, a weight corresponding to a low EV frame may be great in the weight map 910 illustrated in FIG. 9A, and a weight corresponding to a high EV frame may be great in the weight map 920 illustrated FIG. 9B. In this case, details of the branch region in the weight map 920 in which the weight corresponding to a high EV frame is great may be relatively good.

As for a sky region, a weight corresponding to a high EV frame may be great in the weight map 910 illustrated in FIG. 9A, and a weight corresponding to a low EV frame may be great in the weight map 920 illustrated in FIG. 9B. In this case, a noise of the sky region in the weight map 920 in which the weight corresponding to the low EV frame is great may be relatively great.

Referring to FIGS. 9A and 9B, since noise characteristics are reflected in the weight maps, different noise information may be obtained based on the weight maps.

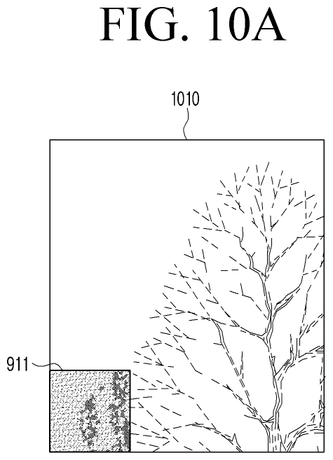

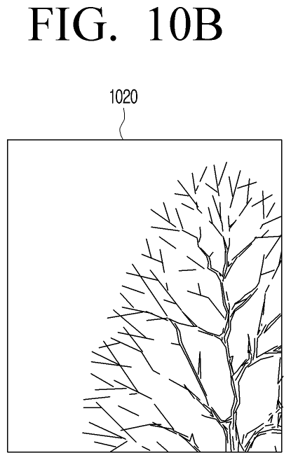

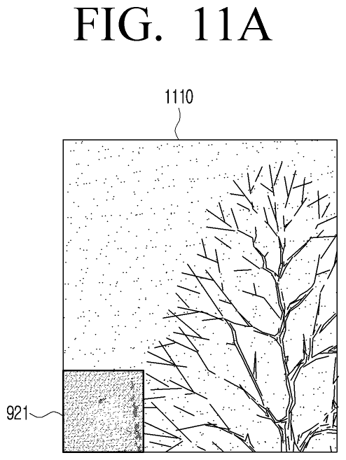

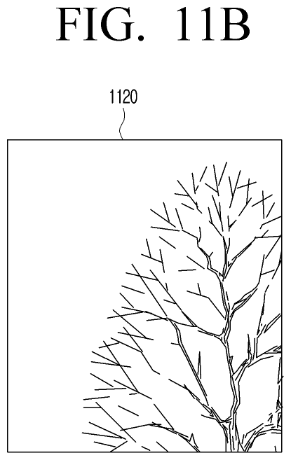

FIGS. 10A, 10B, 11A, and 11B illustrate a method of obtaining noise information based on semantic segmentation information according to various embodiments of the disclosure.

FIG. 10A illustrates an image 1010 of a region of interest in the output image corresponding to epoch=4980. Referring to FIG. 10A, a weight corresponding to a low EV frame may be great considering a weight map 911 of a branch region requiring details. Accordingly, a noise may be added further to the branch region with reference to the semantic segmentation information such that details of a branch may improve as shown in a corrected output image 1020 illustrated in FIG. 10B.

FIGS. 11A and 11B illustrate an image 1110 (an image 1120 in FIG. 11B) of a region of interest 921 in the output image corresponding to epoch=12020. Referring to FIG. 11A, under the assumption that a weight corresponding to a low EV frame is great in both a branch region and a sky region, in the case where an identical noise is added to both the branch region and the sky region, the sky region is highly likely to look relatively noisy. In this case, with reference to the semantic segmentation information, less noises may be added to the sky region to prevent the sky portion from being severely noisy.

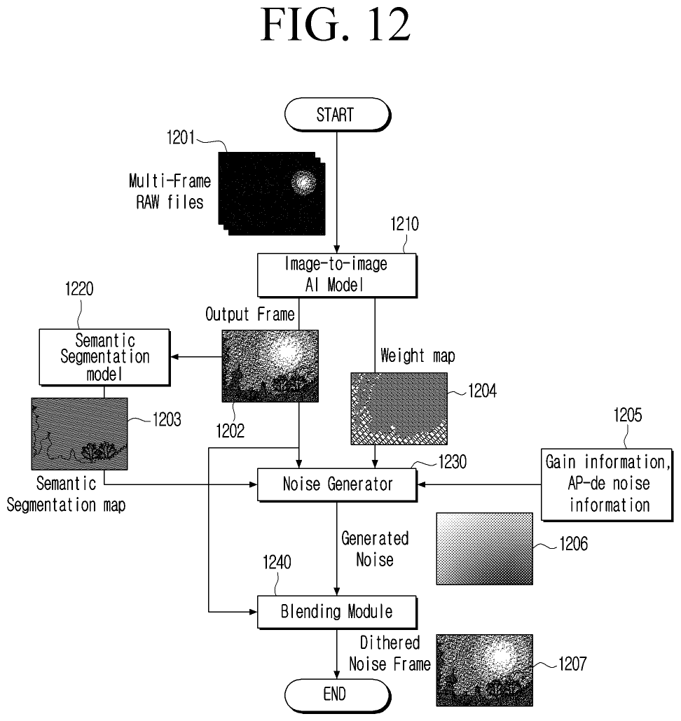

FIG. 12 illustrates a method of correcting an output image according to an embodiment of the disclosure.

Referring to FIG. 12, according to one embodiment of the disclosure, each operation module 1210, 1220, 1230 and 1240 illustrated in FIG. 12 may be implemented as at least one software, at least one hardware and/or a combination thereof. For example, each operation module 1210, 1220, 1230 and 1240 may be implemented to use a predefined algorithm, a predefined formula and/or an AI model. Each operation module 1210, 1220, 1230 and 1240 may be included in the electronic apparatus 100, but in one example, may be distributed in at least one external apparatus.

Referring to FIG. 12, the electronic apparatus 100 may obtain an output frame 1202 by inputting a multi-frame raw file 1201 obtained through capturing to an image-to-image artificial intelligence (AI) model 1210.

The multi-frame raw file may be formed in the way that a plurality of raw frames is stored as one single file. For example, the camera 130 may capture several images continuously at very short time intervals, based on multiple capturing(exposure), and store the images in the form of one single file, in the memory 120. The image-to-image AI model 1210 may be implemented as an image signal processor (ISP) or a software image signal processor (SWISP). The ISP (or SWISP) may be hardware that reduces a digital noise occurring at a time of image capturing, or performs image processing, such as an image correction after capturing, a high dynamic range (HDR).

For example, the image-to-image AI model 1210 may be one implementation example of the first AI model described in operation 430 of FIG. 4. In the case where the multi-frame raw file is input, the image-to-image AI model 1210 may be a deep learning model that performs a task of synthesizing a plurality of raw frames included in the multi-frame raw file and generating an output image. For example, the image-to-image AI model 1210 may generate one output frame by selecting only portions having an optimal exposure in each of the plurality of raw frames. For example, the image-to-image AI model may be implemented as an AI model using a deep learning algorithm, such as generative adversarial networks (GANs), variational autoencoders (VAEs), or diffusion models.

In one example, the electronic apparatus 100 may obtain a semantic segmentation map 1203 by inputting the output frame to a semantic segmentation model 1220. The semantic segmentation model 1220 may be one implementation example of the second AI model described in operation 440 of FIG. 4. In one example, the semantic segmentation model 1220 may classify each pixel included in an image into a specific class (e.g., human, sky, tree, and vehicle). In one example, the semantic segmentation map may be formed into a map including semantic information on a specific class (e.g., human, sky, tree, and vehicle) allocated to each pixel in an image. The semantic information may be formed into a label (e.g., a color, an indicator, a flag, a text and the like) indicating an object or a background to which each pixel belongs.

In one example, the electronic apparatus 100 may obtain a weight map 1204 from the image-to-image AI model 1210. For example, the weight map 1204 may be information indicating how much a specific region (e.g., each pixel) of each raw image contributes to a final synthesis image when the image-to-image AI model 1210 combine raw images captured under different exposure conditions. For example, the weight map 1204 may be one example of the weight information described in operation 450 of FIG. 4.

In one example, the electronic apparatus 100 may obtain a noise image 1206 by inputting the output image 1202, the semantic segmentation map 1203, and the weight map 1204 to a noise generator 1230. For example, the noise image may be formed into a map including a noise value for each pixel. In one example, the noise value may be formed into digital grain. The digital grain may be a pattern like a small particle shown in a digital image. For example, the noise image 1206 may be one example of the noise information described in operation 450 of FIG. 4.

In one example, the electronic apparatus 100 may obtain the noise image 1206 by additionally inputting at least one 1205 of gain information of the camera 130 and de-noise information of an application processor (AP) as well as the output image 1202, the semantic segmentation map 1203, and the weight map 1204 to the noise generator 1230.

For example, the gain information of the camera 130 may be digital camera settings that control signal amplification of a camera sensor. The camera 130 may provide an automatic gain (or autogain; AGC) function, and the AGC function may be turned on/off manually. A gain may be performed before and/or after an analog-to-digital converter (ADC). The gain may amplify all signals including a relevant background noise. Accordingly, as a gain value increases, a noise may also be amplified while a signal is amplified. At this time, it may be appropriate to decrease a noise relatively in the case of a high gain value, while it may be appropriate to amplify a noise relatively in the case of a low gain value. For example, in the case where the gain information is additionally input to the noise generator 1230, since the noise generator 1230 may identify an amplification degree of a noise (e.g., a noise of the weight map or the semantic segmentation map) generated previously based on the gain information, the noise may be decreased relatively in the case of a high gain value, and on the other hand, the noise may be amplified relatively in the case of a low gain value to generate the noise image 1206.

For example, de-noise information of the application processor (AP) may include de-noise information of the image-to-image AI model 1210. The de-noise information of the image-to-image AI model 1210 may be information corresponding to before/after de-noise processing in the case where the de-noise processing is performed in the image-to-image AI model 1210 to improve the quality of an image, which deteriorates because of capturing of low illuminance. For example, a “removed noise” as a result of de-noise processing based on a difference in images before/after the image-to-image AI model 1210 processing may be calculated, and the “removed noise” calculated as described above may be additionally input to the noise generator 1230 to obtain the noise image 1206. For example, in the case where the de-noise information of the AP is additionally input to the noise generator 1230, since the noise generator 1230 may identify a de-noise level based on the de-noise information of the AP, a generated noise may be added strongly in a region that is de-noised well and may be added weakly in a region that is not de-noised well to generate the noise image 1206. Meanwhile, in the case where the de-noise processing is performed by another application processor (AP) except for the image-to-image AI model 1210, corresponding de-noise information may be additionally input to the noise generator 1230.

In one example, the electronic apparatus 100 may blend the output image 1202 and the noise image 1206 to obtain a dithered noise frame 1207 by using a blending module 1240 (or a synthesis module). In that noise addition processing is referred to as dithering, an image in which the output image 1202 and the noise image 1206 are blended is referred to as a dithered noise frame 1207. For example, the dithered noise frame 1207 may be one example of the corrected output image described in operation 460 of FIG. 4. For example, since dithering as a technology used to reduce an image of low bit depth in digital image processing or color banding or other visual artifacts in a display is a technical solution in the disclosure, a finally corrected image is referred to as a dithered noise frame 1207. In one example, the electronic apparatus 100 may obtain the dithered noise frame 1207 by blending the noise image to the output image. For example, the electronic apparatus 100 may blend a pixel value of the output image and a pixel value included in the noise map through alpha blending. For example, the blending module 1240 may blend the pixel value of the output image and the pixel value included in the noise map based on a formula of “Blended image=α×output image+(1−α)×noise image”. Herein, the α value may be a weighted sum ratio of the output image and the noise image. For example, as α becomes closer to 1, the output image may be reflected further, and as α becomes closer to 0, the noise image may be reflected further. The α value may be a preset value, but may be set/changed based on a user input.

The blending module 1240 may perform blending of the output image 1202 and the noise image 1206 in at least one of a YUV domain or an RGB domain.

In one example, the blending module 1240 may perform blending by adding to an R/G/B value of each pixel included in the noise image 1206 of the RGB domain to an R/G/B value of each pixel included in the output image 1202 of the RGB domain.

In one example, the electronic apparatus 100 may perform noise blending by converting the output image 1202 of the RGB domain and the noise image 1206 of the RGB domain respectively into an output image and a noise image of the YUV domain. In the YUV domain, Y may include brightness (luminance), and U and V may include chrominance. For example, the blending module 1240 may perform the noise blending by applying a different weight to a Y channel, a U channel and a V channel. For example, the blending module 1240 may add a relatively strong noise to the Y channel including brightness information, and add a relatively fine noise to the U channel and the V channel. This is because the human eye is more sensitive to a change in brightness and less sensitive to a change in color.

According to one embodiment of the disclosure, a shape of an input/output and a data type of each model layer, a layer name, a structure, a meaning of an input/output and the like may be confirmed through reverse-engineering corresponding to an AI model in binary of another electronic apparatus. Additionally, a noise added to an output may be identified by comparing results of an input/output of the AI model, and based on the identification, infringement of the disclosure may be found.

FIG. 13 is a block diagram of an electronic apparatus in a network environment according to an embodiment of the disclosure. In one example, the electronic apparatus 1301 may be implemented as an electronic apparatus 100 illustrated in FIG. 3.

Referring to FIG. 13, in a network environment 1300, an electronic apparatus 1301 may communicate with an external electronic apparatus 1302 through a first network 1398 (e.g., a short-range wireless communication network) or communication with at least one of an external electronic apparatus 1304 or a server 1308 through a second network 1399 (e.g., a long-distance wireless communication network). According to one embodiment of the disclosure, the electronic apparatus 1301 may communicate with the external electronic apparatus 1304 through the server 1308. According to one embodiment of the disclosure, the electronic apparatus 1301 may include a processor 1320, memory 1330, an input module 1350, a sound output module 1355, a display module 1360, an audio module 1370, a sensor module 1376, an interface 1377, a connection terminal 1378, a haptic module 1379, a camera module 1380, a power management module 1388, a battery 1389, a communication module 1390, a subscriber identification module 1396, or an antenna module 1397. In some embodiments of the disclosure, the electronic apparatus 1301 may exclude at least one (e.g., a connection terminal 1378) of the elements, or add one or more other elements. In some embodiments of the disclosure, some (e.g., a sensor module 1376, a camera module 1380, or an antenna module 1397) of the elements may be integrated into one element (e.g., a display module 1360).

The processor 1320, for example, may control at least one another element (e.g., a hardware or software element) of the electronic apparatus 1301 connected to the processor 1320 by executing software (e.g., a program 1340), and process various types of data or perform a computation. According to one embodiment of the disclosure, as at least part of data processing or a computation, the processor 1320 may store instructions or data received from another element (e.g., a sensor module 1376 or a communication module 1390) in volatile memory 1332, process the instructions or data stored in the volatile memory 1332, and store resultant data in non-volatile memory 1334. According to one embodiment of the disclosure, the processor 1320 may include a main processor 1321 (e.g., a central processing unit or an application processor) or a co-processor 1323 (e.g., a graphics processing unit, a neural processing unit (NPU), an image signal processor, a sensor hub processor, or a communication processor) capable of operating independently from or together with the main processor. For example, in the case where the electronic apparatus 1301 includes the main processor 1321 and the co-processor 1323, the co-processor 1323 may consume less power than the main processor 1321, or may be set to specialize in a designated function. The co-processor 1323 may be implemented apart from the main processor 1321 or as part of the main processor 1321.

The co-processor 1323, for example, may control at least part of functions or states associated with at least one (e.g., a display module 1360, a sensor module 1376 or a communication module 1390) of the elements of the electronic apparatus 1301 in replacement of the main processor 1321 in the state where the main processor 1321 is inactivated (e.g., a sleep), or together with the main processor 1321 in the state where the main processor 1321 is activated (e.g., execution of an application). According to one embodiment of the disclosure, the co-processor 1323 (e.g., an image signal processor or a communication processor) may be implemented as part of another element (e.g., a camera module 1380 or a communication module 1390) associated functionally. According to one embodiment of the disclosure, the co-processor 1323 (e.g., a neural processing unit) may include a hardware structure specializing in processing of an AI model. The AI model may be generated through machine learning. Such learning, for example, may be performed in the electronic apparatus 1301 itself where an AI model is performed, or may be performed through a separate server (e.g., a server 1308). A learning algorithm, for example, may include supervised learning, unsupervised learning, semi-supervised learning or reinforcement learning, but not be limited thereto. The AI model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network or a combination of two or more thereof, but not limited thereto. The AI model may include a software structure additionally or replaceably in addition to a hardware structure.

The memory 1330 may store various types of data used by at least one element (e.g., a processor 1320 or a sensor module 1376) of the electronic apparatus 1301. The data, for example, may include software (e.g., a program 1340), and input data or output data of an instruction associated with the software. The memory 1330 may include volatile memory 1332 or non-volatile memory 1334. The non-volatile memory 1334 may include built-in memory 1336 or external memory 1338.

The program 1340 may be stored as software in the memory 1330, and for example, include an operating system 1442, middleware 1444 or an application 1446.

The input module 1350 may receive an instruction or data to be used in an element (e.g., a processor 1320) of the electronic apparatus 1301 from an outside (e.g., a user) of the electronic apparatus 1301. The input module 1350, for example, may include a microphone, a mouse, a keyboard, a key (e.g., a button), or a digital pen (e.g., a stylus pen).

The sound output module 1355 may output a sound signal to the outside of the electronic apparatus 1301. The sound output module 1355, for example, may include a speaker or a receiver. The speaker may be used for a normal purpose, such as a playback of multimedia or a playback of recording. The receiver may be used to receive incoming calls. According to one embodiment of the disclosure, the receiver may be implemented apart from the speaker or as part of the speaker.

The display module 1360 may provide information visually to the outside (e.g., a user) of the electronic apparatus 1301. The display module 1360, for example, may include a display, a hologram device, or a projector and control circuit for controlling the above-described devices. According to one embodiment of the disclosure, the display module 1360 may include a touch sensor configured to detect a touch, or a pressure sensor configured to measure intensity of force generated by a touch.

The audio module 1370 may convert a sound into an electrical signal, or on the contrary, convert an electrical signal into a sound. According to one embodiment of the disclosure, the audio module 1370 may obtain a sound through the input module 1350, or output a sound through the sound output module 1355 or an external electronic apparatus (e.g., the external electronic apparatus 1302 (e.g., a speaker or a headset)) connected to the electronic apparatus 1301 directly or wirelessly.

The sensor module 1376 may detect an operation state (e.g., power or temperature) of the electronic apparatus 1301, or an external environment state (e.g., a user state), and generate an electrical signal or a data value corresponding to the detected state. According to one embodiment of the disclosure, the sensor module 1376, for example, may include a gesture sensor, a gyro sensor, a barometric pressure sensor, a magnetic sensor, an acceleration sensor, a grip sensor, a proximity sensor, a color sensor, an infrared (IR) sensor, a bio-physical sensor, a temperature sensor, a humidity sensor, or an illuminance sensor.

The interface 1377 may assist with one or more designated protocols that may be used for the electronic apparatus 1301 to be connected with an external electronic apparatus (e.g., the external electronic apparatus 1302) directly or wirelessly. According to one embodiment of the disclosure, the interface 1377, for example, may include a high definition multimedia interface (HDMI), a universal serial bus (USB) interface, an SD card interface or an audio interface.

The connection terminal 1378 may include a connector through which the electronic apparatus 1301 may be connected with an external electronic apparatus (e.g., the external electronic apparatus 1302) physically. According to one embodiment of the disclosure, the connection terminal 1378, for example, may include a HDMI connector, a USB connector, an SD card connector, or an audio connecter (e.g., a headset connector).

The haptic module 1379 may convert an electrical signal into mechanical stimulation (e.g., vibrations or movements) that may be recognized by the user through a sense of touch or a kinesthetic detect or into electrical stimulation. According to one embodiment of the disclosure, the haptic module 1379, for example, may include a motor, a piezoelectric element or an electrical stimulation device.

The camera module 1380 may capture a still image and a moving image. According to one embodiment of the disclosure, the camera module 1380 may include one or more lenses, image sensors, image signal processors or flashes.

The power management module 1388 may manage power that is supplied to the electronic apparatus 1301. According to one embodiment of the disclosure, the power management module 1388, for example, may be implemented as at least part of power management integrated circuit (PMIC).

The battery 1389 may supply power to at least one element of the electronic apparatus 1301. According to one embodiment of the disclosure, the battery 1389, for example, may include a primary battery that is not rechargeable, and a secondary battery or a fuel cell that is rechargeable.

The communication module 1390 may assist with an establishment of a direct (e.g., wired) communication channel or a wireless communication channel between the electronic apparatus 1301 and an external electronic apparatus (e.g., the external electronic apparatus 1302, the external electronic apparatus 1304 or a server 1308), and performance of communication through the established communication channel. The communication module 1390 may include one or more communication processors that are operated independently from the processor 1320 (e.g., an application processor) and assists with direct (e.g., wired) communication or wireless communication. According to one embodiment of the disclosure, the communication module 1390 may include a wireless communication module 1392 (e.g., a cellular communication module, a short-range wireless communication module, or a global navigation satellite system (GNSS) communication module) or a wired communication module 1494 (e.g., a local area network (LAN) communication module or a power line communication module). Among communication modules, the above-described communication modules may communicate with the external electronic apparatus 1304 through a first network 1398 (e.g., a short-range communication network, such as Bluetooth, wireless fidelity (Wi-Fi) direct or infrared data association (IrDA)) or a second network 1399 (e.g., a long-distance communication network, such as a legacy cellular network, a 5G network, a next-generation communication network, the Internet or a computer network (e.g., LAN or WAN). Various types of communication modules described above may be integrated into one element (e.g., a single chip), or implemented as a plurality of separate elements (e.g., a plurality of chips). The wireless communication module 1392 may confirm or verify the electronic apparatus 1301 in a communication network, such as a first network 1398 or a second network 1399 by using subscriber information (e.g., International Mobile Subscriber Identity (IMSI)) stored in the subscriber identification module 1396.

The wireless communication module 1392 may assist with a 5G network after a fourth generation (4G) network and a next-generation communication technology, e.g., a new radio (NR) access technology. The NR access technology may assist with enhanced mobile broadband (eMBB), massive machine type communications (mMTC), or ultra-reliable and low-latency communications (URLLC). The wireless communication module 1392, for example, may assist with a high-frequency band (e.g., a millimeter wave (mmWave) band) to achieve a high data transmission rate. The wireless communication module 1392 may assist with various technologies for securing performance in a high-frequency band, such as beamforming, multiple-input and multiple-output (massive MIMO), full dimensional MIMO (FD-MIMO), an array antenna, analog beam-forming, or a large scale antenna. The wireless communication module 1392 may assist with various requirements regulating an electronic apparatus 1301, an external electronic apparatus (e.g., the external electronic apparatus 1304) or a network system (e.g., a second network 1399). According to one embodiment of the disclosure, the wireless communication module 1392 may assist with a peak data rate (e.g., 20 Gbps or greater) for realizing eMBB, loss coverage (e.g., 164 dB or less) for realizing mMTC or U-plane latency (e.g., a downlink (DL) and an uplink (UL) of 0.5 ms or less respectively, or a round trip of 1 ms or less) for realizing URLLC.

The antennal module 1397 may transmit a signal or power to an outside (e.g., an external electronic apparatus) or receive a signal or power from the outside. According to one embodiment of the disclosure, the antenna module 1397 may include an antenna including a conductor or a radiator comprised of a conductive pattern that is formed on a substrate (e.g., a printed circuit board (PCB)). According to one embodiment of the disclosure, the antenna module 1397 may include a plurality of antennas (e.g., an array antenna). In this case, at least one antenna appropriate for a communication method used in a communication network, such as a first network 1398 or a second network 1399 may be selected from the plurality of antennas, for example, by the communication module 1390. A signal or power may be transmitted or received between the communication module 1390 and an external electronic apparatus through the at least one antenna selected. According to some embodiments of the disclosure, another component (e.g., a radio frequency integrated circuit (RFIC)) may be additionally formed as part of the antenna module 1397 in addition to the radiator.

According to various embodiments of the disclosure, the antenna module 1397 may form an mmWave antenna module. According to one embodiment of the disclosure, the mmWave antenna module may include a printed circuit board, an RFIC that is disposed on or near a first surface (e.g., a lower surface) of the printed circuit board and capable of assisting with a designated high-frequency band (e.g., an mmWave band), and a plurality of antennas (e.g., an array antenna) that is disposed on or near a second surface (e.g., an upper surface or a side) of the printed circuit board and capable of transmitting or receiving a signal in the designated high-frequency band).

At least part of the above-described elements may be connected with one another and exchange a signal (e.g., an instruction or data) with one another based on a communication method (e.g., a bus, a general purpose input and output (GPIO), a serial peripheral interface (SPI) or a mobile industry processor interface (MIPI)) performed among peripherals.

According to one embodiment of the disclosure, instructions or data may be transmitted or received between the electronic apparatus 1301 and the external electronic apparatus 1304 through the server 1308 connected to the second network 1399. Each external electronic apparatus (1302 or 1304) may be an apparatus of a type identical with or different from a type of the electronic apparatus 1301. According to one embodiment of the disclosure, all or part of the operations performed by the electronic apparatus 1301 may be performed by one or more of the external electronic apparatuses 1302 or 1304, or the server 1308). For example, in the case where the electronic apparatus 1301 performs a certain function or service automatically or in response to a request from the user or another apparatus, the electronic apparatus 1301 may request one or more of the external electronic apparatuses to perform at least part of the function or service, rather than performing the function or service on its own or additionally. Having received the request, one or more of the external electronic apparatuses perform at least part of the requested function or service, or an additional function or service associated with the request, and may deliver results of the performance to the electronic apparatus 1301. The electronic apparatus 1301 may provide the results themselves or additionally process the results and provide the same, as at least part of a response to the request. To this end, technologies of cloud computing, distributed computing, mobile edge computing (MEC), or client-server computing may be used, for example. The electronic apparatus 1301, for example, may provide an ultra-low latency service by using the technology of distributed computing or mobile edge computing. According to another embodiment of the disclosure, the external electronic apparatus 1304 may include an Internet of things device (IoT). The server 1308 may be an intelligent server using machine learning and/or a neural network. According to one embodiment of the disclosure, the external electronic apparatus 1304 or the server 1308 may be included in the second network 1399. The electronic apparatus 1301 may be applied to an intelligent service (e.g., a smart home, a smart city, a smart car, or healthcare) based on the 5G communication technology and IoT associated technologies.

According to one embodiment of the disclosure, an electronic apparatus 100 includes memory 120 storing instructions; a camera 130; and at least one processor 110 including processing circuitry, and the instructions, when executed individually or collectively by the at least one processor 110, cause the electronic apparatus 100 to, based on an event for capturing being identified, obtain a plurality of raw images having different exposure values through the camera 130, obtain a synthesized output image by using the plurality of raw images, obtain weight information for each region included in the output image associated with a synthesis degree of each of the plurality of raw images used in obtaining the output image, obtain semantic segmentation information corresponding to the output image, obtain noise information based on the semantic segmentation information and the weight information, and obtain a corrected output image based on the output image and the noise information.

According to one embodiment of the disclosure, the instructions, when executed by the at least one processor individually or collectively, may cause the electronic apparatus to synthesize the plurality of raw images based on the exposure values of the plurality of raw images to obtain the output image by using an image conversion module.

According to one embodiment of the disclosure, the instructions, when executed by the at least one processor individually or collectively, may cause the electronic apparatus to input the plurality of raw images to a first AI model included in the image conversion module to obtain the output image which is de-noised, and the weight information may be information including noise characteristics of the plurality of raw images.

According to one embodiment of the disclosure, the instructions, when executed by the at least one processor individually or collectively, may cause the electronic apparatus to obtain a first map including the weight information from the image conversion module, obtain a second map including the semantic segmentation information by using a second AI model, obtain a third map including the noise information based on the output image, the first map, and the second map, and obtain the corrected output image by blending the output image and the third map.

According to one embodiment of the disclosure, the instructions, when executed by the at least one processor individually or collectively, may cause the electronic apparatus to, based on the semantic segmentation information of each region included in the output image, obtain the noise information by adjusting a weight of each region of the output image, and the semantic segmentation information may include class information of an object corresponding to a region of the image.

According to one embodiment of the disclosure, the instructions, when executed by the at least one processor individually or collectively, may cause the electronic apparatus to, based on a first region and a second region included in the output image including a pixel value of a raw image of which an exposure value is relatively low, among the plurality of raw images, adjust a noise of the first region and a noise of the second region based on semantic segmentation information of the first region and the second region.

According to one embodiment of the disclosure, the instructions, when executed by the at least one processor individually or collectively, may cause the electronic apparatus to, based on a first object included in the first region being an object which requires a detail enhancing processing compared to a second object included in the second region, obtain the noise information in which a noise of the first region is greater than a noise of the second region.

According to one embodiment of the disclosure, the instructions, when executed by the at least one processor individually or collectively, may cause the electronic apparatus to obtain the noise information by inputting the output image, the semantic segmentation information, and the weight information to a third AI model.

According to one embodiment of the disclosure, the instructions, when executed by the at least one processor individually or collectively, may cause the electronic apparatus to obtain the noise information by additionally inputting at least one of gain information of the camera and de-noise information of the image conversion module to the third AI model.

According to one embodiment of the disclosure, the noise information may include digital grain information.

According to one embodiment of the disclosure, a method of controlling an electronic apparatus includes based on an event for capturing being identified, obtaining a plurality of raw images having different exposure values through the camera; obtaining an output image by using the plurality of raw images; obtaining weight information for each region included in the output image associated with a synthesis degree of each of the plurality of raw images used in obtaining the output image; obtaining semantic segmentation information corresponding to the output image; obtaining noise information based on the semantic segmentation information and the weight information; and obtaining a corrected output image based on the output image and the noise information.

According to one embodiment of the disclosure, the obtaining an output image may include synthesizing the plurality of raw images based on the exposure values of the plurality of raw images to obtain the output image by using an image conversion module.

According to one embodiment of the disclosure, the obtaining an output image may include inputting the plurality of raw images to a first AI model included in the image conversion module to obtain the output image which is de-noised, and the weight information may be information including noise characteristics of the plurality of raw images.

According to one embodiment of the disclosure, the obtaining a corrected output image may include: obtaining a first map including the weight information from the image conversion module; obtaining a second map including the semantic segmentation information by using a second AI model; obtaining a third map including the noise information based on the output image, the first map, and the second map; and obtaining the corrected output image by blending the output image and the third map.

According to one embodiment of the disclosure, the obtaining noise information may include based on the semantic segmentation information of each region included in the output image, obtaining the noise information by adjusting a weight of each region of the output image, and the semantic segmentation information may include class information of an object corresponding to a region of the image.

According to one embodiment of the disclosure, the obtaining noise information may include based on a first region and a second region included in the output image including a pixel value of a raw image of which an exposure value is relatively low, among the plurality of raw images, adjusting a noise of the first region and a noise of the second region based on semantic segmentation information of the first region and the second region.

According to one embodiment of the disclosure, the obtaining noise information may include based on a first object included in the first region being an object which requires a detail enhancing processing compared to a second object included in the second region, obtaining the noise information in which a noise of the first region is greater than a noise of the second region.

According to one embodiment of the disclosure, the obtaining noise information may include obtaining the noise information by inputting the output image, the semantic segmentation information, and the weight information to a third AI model.

According to one embodiment of the disclosure, the obtaining noise information may include obtaining the noise information by additionally inputting at least one of gain information of the camera and de-noise information of the image conversion module to the third AI model.

According to one embodiment of the disclosure, in a non-transitory computer readable medium storing computer instructions that cause an electronic apparatus to perform operations when the instructions are executed by a processor of the electronic apparatus, the operations include: based on an event for capturing being identified, obtaining a plurality of raw images having different exposure values through the camera; obtaining an output image by using the plurality of raw images; obtaining weight information for each region included in the output image associated with a synthesis degree of each of the plurality of raw images used in obtaining the output image; obtaining semantic segmentation information corresponding to the output image; obtaining noise information based on the semantic segmentation information and the weight information; and obtaining a corrected output image based on the output image and the noise information.

According to the embodiments of the disclosure described above, a noise that is adaptive based on image characteristics may be generated such that dithering is performed, thereby securing improvement in image quality.

In the embodiments described above, description is provided under the assumption that a plurality of individual AI models is used, but operations of at least two AI models among a plurality of neural network models may be implemented by one AI model.

According to the embodiments of the disclosure described above, each operation may be performed by the processor 110, but when necessary, a module for each operation may be used to perform each operation. For example, each module may be implemented as at least one software, at least one hardware and/or a combination thereof. Each module may be implemented to use a predefined algorithm, a predefined formula and/or a trained AI model to perform an operation. However, at least part of the modules may be distributed in an external apparatus.

According to the embodiments of the disclosure described above, the methods may be implemented in the form of an application that is installable in an existing electronic apparatus. Alternatively, according to the embodiments of the disclosure, the methods may be performed by using a deep learning-based artificial neural network (or a deep artificial neural network), i.e., a learning network model.

According to the embodiments described above, the methods may be implemented merely by upgrading software or hardware of an existing electronic apparatus.

The embodiments described above may be implemented through an embedded server provided in an electronic apparatus or an external server of an electronic apparatus.

According to the disclosure, the embodiments described above may be implemented as software including instructions stored in a storage medium readable by a machine (e.g., a computer). The machine, as a device capable of calling the stored instructions from the storage media and operating according to the called instructions, may include an electronic apparatus (e.g., an electronic apparatus (A)) according to the disclosed embodiments. When instructions are executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” means that the storage medium does not include a signal and only means that the storage medium is tangible, while the term does not distinguish semi-permanent or temporary storage of data in the storage medium.

In the disclosure, the methods according to the embodiments described above may be provided in a computer program product. The computer program product may be exchanged between a seller and a purchaser as a commodity. The computer program product may be distributed in the form of a machine-readable storage medium (e.g., compact disc read only memory (CD-ROM)), or distributed online through an application store (e.g., Play Store™). In the case of online distribution, at least part of the computer program product may be stored at least temporarily, or generated temporarily in a storage medium, such as a server of a manufacturer, a server of an application store, or memory of a relay server.

Each of the elements (e.g., a module or a program) according to the embodiments described above may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform identical or similar functions performed by each corresponding element prior to the integration. Operations performed by a module, a program, or another element, according to the embodiments of the disclosure, may be executed sequentially, in parallel, repetitively, or heuristically, or at least part of the operations may be executed in a different order, may be omitted, or may add a different operation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
memory, comprising one or more storage media, storing instructions;
a camera; and
at least one processor including processing circuitry communicatively coupled to the memory and the camera,
wherein the instructions, when executed by the at least one processor individually or collectively, cause the electronic apparatus to:
based on an event for capturing being identified, obtain a plurality of raw images having different exposure values through the camera,
obtain an output image by using the plurality of raw images,
obtain weight information for each region included in the output image associated with a synthesis degree of each of the plurality of raw images used in obtaining the output image,
obtain semantic segmentation information corresponding to the output image,
obtain noise information based on the semantic segmentation information and the weight information, and
obtain a corrected output image based on the output image and the noise information.

2. The electronic apparatus of claim 1, wherein the instructions, when executed by the at least one processor individually or collectively, further cause the electronic apparatus to:
synthesize the plurality of raw images based on the exposure values of the plurality of raw images to obtain the output image by using an image conversion module.

3. The electronic apparatus of claim 2,
wherein the instructions, when executed by the at least one processor individually or collectively, further cause the electronic apparatus to:
input the plurality of raw images to a first artificial intelligence (AI) model included in the image conversion module to obtain the output image which is de-noised, and
wherein the weight information is information including noise characteristics of the plurality of raw images.

4. The electronic apparatus of claim 2, wherein the instructions, when executed by the at least one processor individually or collectively, further cause the electronic apparatus to:
obtain a first map including the weight information from the image conversion module,
obtain a second map including the semantic segmentation information by using a second AI model,
obtain a third map including the noise information based on the output image, the first map, and the second map, and
obtain the corrected output image by blending the output image and the third map.

5. The electronic apparatus of claim 1,
wherein the instructions, when executed by the at least one processor individually or collectively, further cause the electronic apparatus to:
based on the semantic segmentation information of each region included in the output image, obtain the noise information by adjusting a weight of each region of the output image, and
wherein the semantic segmentation information comprises class information of an object corresponding to a region of the image.

6. The electronic apparatus of claim 5, wherein the instructions, when executed by the at least one processor individually or collectively, further cause the electronic apparatus to:
based on a first region and a second region included in the output image comprising a pixel value of a raw image of which an exposure value is relatively low, among the plurality of raw images, adjust a noise of the first region and a noise of the second region based on semantic segmentation information of the first region and the second region.

7. The electronic apparatus of claim 6, wherein the instructions, when executed by the at least one processor individually or collectively, further cause the electronic apparatus to:
based on a first object included in the first region being an object which requires a detail enhancing processing compared to a second object included in the second region, obtain the noise information in which a noise of the first region is greater than a noise of the second region.

8. The electronic apparatus of claim 2, wherein the instructions, when executed by the at least one processor individually or collectively, further cause the electronic apparatus to:
obtain the noise information by inputting the output image, the semantic segmentation information, and the weight information to a third AI model.

9. The electronic apparatus of claim 8, wherein the instructions, when executed by the at least one processor individually or collectively, further cause the electronic apparatus to:
obtain the noise information by additionally inputting at least one of gain information of the camera and de-noise information of the image conversion module to the third AI model.

10. The electronic apparatus of claim 1, wherein the noise information comprises digital grain information.

11. A method of controlling an electronic apparatus, the method comprising:
based on an event for capturing being identified, obtaining a plurality of raw images having different exposure values through a camera;
obtaining an output image by using the plurality of raw images;
obtaining weight information for each region included in the output image associated with a synthesis degree of each of the plurality of raw images used in obtaining the output image;
obtaining semantic segmentation information corresponding to the output image;
obtaining noise information based on the semantic segmentation information and the weight information; and
obtaining a corrected output image based on the output image and the noise information.

12. The method of claim 11, wherein the obtaining an output image comprising:
synthesizing the plurality of raw images based on the exposure values of the plurality of raw images to obtain the output image by using an image conversion module.

13. The method of claim 12, wherein the obtaining an output image comprising:
inputting the plurality of raw images to a first artificial intelligence (AI) model included in the image conversion module to obtain the output image which is de-noised,
wherein the weight information is information including noise characteristics of the plurality of raw images.

14. The method of claim 12, wherein the obtaining a corrected output image comprising:
obtaining a first map including the weight information from the image conversion module;
obtaining a second map including the semantic segmentation information by using a second AI model;
obtaining a third map including the noise information based on the output image, the first map, and the second map; and
obtaining the corrected output image by blending the output image and the third map.

15. The method of claim 11, further comprising:
based on the semantic segmentation information of each region included in the output image, obtaining the noise information by adjusting a weight of each region of the output image,
wherein the semantic segmentation information comprises class information of an object corresponding to a region of the image.

16. The method of claim 15, further comprising:
based on a first region and a second region included in the output image comprising a pixel value of a raw image of which an exposure value is relatively low, among the plurality of raw images, adjusting a noise of the first region and a noise of the second region based on semantic segmentation information of the first region and the second region.

17. The method of claim 16, further comprising:
based on a first object included in the first region being an object which requires a detail enhancing processing compared to a second object included in the second region, obtaining the noise information in which a noise of the first region is greater than a noise of the second region.

18. The method of claim 11, further comprising:
obtaining the noise information by inputting the output image, the semantic segmentation information, and the weight information to a third AI model.

19. One or more non-transitory computer-readable storage media storing one or more computer programs including computer-executable instructions that, when executed by one or more processors individually or collectively, cause an electronic apparatus to perform operations, the operations comprising:
based on an event for capturing being identified, obtaining a plurality of raw images having different exposure values through a camera;
obtaining an output image in which the plurality of raw images is synthesized by using an image conversion module;
obtaining weight information in which noise characteristics of the plurality of raw images used in the synthesis are reflected;
obtaining noise information based on semantic segmentation information corresponding to the output image and the weight information; and
obtaining a corrected output image based on the output image and the noise information.

20. The one or more non-transitory computer-readable storage media of claim 19, wherein the obtaining an output image comprising:
synthesizing the plurality of raw images based on the exposure values of the plurality of raw images to obtain the output image by using an image conversion module.
